(19) United States
(12) Patent Application Publication
(10) Pub. No.: US 2002/0037698 A1
(43) Pub. Date: Mar. 28, 2002

(54) Data receiving apparatus

(76) Inventors: Gary Patrick Stafford, St. Albans (GB); David Gerald Smith, Knebworth (GB); John Davidson, Malmesbury (GB)

Correspondence Address: John V. Moriarty, Woodard, Emhardt, Naughton,Moriarty and McNett, Bank One Center/Tower, 111 Monument Circle, Suite 3700, Indianapolis, IN, 46204-5137, US

(21) Appl. No.: 09/949,737

(22) Filed: Sep. 10, 2001

(30) Foreign Application Priority Data
Sep. 22, 2000 (GB) 0023269.4

(51) Int. Cl. H04H 1/00

(52) U.S. Cl. 455/3.02; 455/278.1

(57) ABSTRACT

The invention which is the subject of this application relates to particularly, although not necessarily exclusively, a form of apparatus known as VSAT. VSAT or Very Small Aperture Terminal is a sophisticated communications technology that allows for the use of small fixed satellite antennas in premises to provide highly reliable communication between a central hub such as a data broadcaster, and almost any number—tens or thousands—of geographically dispersed sites or premises. The invention allows the provision of a Ground Outdoor Unit ODU for the apparatus in an integrated format without the need for separate components to be provided by using progressive amplification and filtering of the transmit or received signal and allowing the required isolation of the receive and transmit signals even at the VSAT apparatus operating conditions. The invention is also of use in any form of signal receive and transmit apparatus.

The invention which is the subject of this application relates to particularly, although not necessarily exclusively, a form of apparatus known as VSAT. VSAT or Very Small Aperture Terminal is a sophisticated communications technology that allows for the use of small fixed satellite antennas in premises to provide highly reliable communication between a central hub such as a data broadcaster, and almost any number—tens or thousands—of geographically dispersed sites or premises. VSAT apparatus is taking on an expanding role in a variety of interactive, on-line data, voice and multimedia applications, such as fuel station services, rural telephony, environmental monitoring, distance learning/remote training, and internet.

The advantages of using satellite networks as opposed to other communication systems, include that with a satellite network, there are no routers and no switches required so that nothing is required between the user and the source of the information, except the transmission system i.e. the sky. The system is easy to understand as there are no physical limitations in terms of geography or distance to make deployment difficult or too expensive. Furthermore, since VSAT satellite communication systems provide a complete end-to-end infrastructure, they can be completely independent from telephone or telecommunications company operators.

Furthermore, VSAT apparatus and systems (VSATs) have a reliability rate and a network available that is significantly higher than terrestrial systems and are particularly effective for broadband data transmission applications. High throughput VSATs offer 40 Mbps downstream and 76.8 Kbps upstream which means that data rich-content material can be delivered live and on-line, or downloaded for later viewing.

VSAT ground terminals have a receive and transmit path to the satellite in which the data is carried between broadcast location and receiver location. In one embodiment referred to as dual polar VSAT a first polarization causes the reception of data and the opposite polarization allows the transmission of data. In a second embodiment referred to as single polar VSAT the transmission and reception of data may be on the same polarization.

In a third embodiment referred to as enhanced dual polar VSAT the transmission and reception of data are on the same polarisation with an additional and opposite polarisation giving greater flexibility and available receive bandwidth.

Some typical frequencies of operation are as follows:

Receive: 10.7-12.75 GHz (usually a section of this band for one system)

Transmit: 13.75-14.5 GHz, power level—different classes of transmitter from a few hundred milliwatts to several watts.

As part of the VSAT system ground terminal outdoor units (ODU's) are required at each of the premises to which data is provided from a broadcaster source.

Conventional dual polar ODU's comprise a number of separate components including a horn, for the “collection” or “transmission” of the receive and transmit signals, an OMT (Ortho mode transducer), waveguide reject filter, a single polarization—low noise block (LNB) and a transmitter to allow the transmission of data from the location to the remote broadcaster. In single polar/enhanced dual polar systems the OMT is omitted and replaced by a power splitter/combiner, and a higher rejection filter is used.

In single polar systems the transmitter element is typically connected to the transmit port of the OMT which is usually a rectangular waveguide interface or similar. The waveguide filter is connected to the receiver port of the OMT which is typically a rectangular waveguide interface and the LNB is connected to the other end of the waveguide filter which is also typically a rectangular waveguide interface. There is a third port on the OMT, which is typically a circular waveguide interface, to which the horn is attached. In single polar versions the transmitter element is connected to one port of the splitter/combiner. The waveguide filter is connected to the second port of the splitter/combiner and the LNB is connected to the other end of the filter.

The principle and conventional requirements in dual polar systems are that the OMT provides a degree of isolation between the transmitter and the LNB and the waveguide filter provides the additional rejection of the 13.75-14.5 GHz transmit signal thus preventing overload, intermodulation and additional noise from either entering or being generated in the LNB. The effect of these various noise sources could in practise range from reduced carrier to noise ratio, to complete non-functionality or overloading of the system. Typically the waveguide filter provides 60-80 dB of rejection of 13.75-14.5 GHz and the OMT around 40-45 dB of rejection giving a total 100-125 dB of isolation from the transmitter to the LNB. In single polar systems the waveguide splitter/combiner does not provide any isolation between the transmitter and the LNB, in this case the rejection of the waveguide filter is increased by 40-45 dB to compensate for the lack of OMT rejection.

However there are disadvantages of the conventional apparatus due to the provision of the above number of components and these disadvantages include the cost of the individual components; the assembly of the components is time consuming and costly and requires professional installation, and the number of components means that there are a number of environmental sealing interfaces which increases the probability of water ingress and eventual system failure and the associated cost of repairing or replacing the same. However, conventionally it has been believed that these costs and disadvantages are required to be borne by the manufacturer and consumer to allow the separation of the various operations of the apparatus effectively.

The aim of the present invention is to overcome these problems by providing apparatus which performs the required functions effectively but without the need of a number of individual components.

In a first aspect of the invention there is provided a ground terminal outdoor unit (ODU) for the reception and communication of broadcast data from and to a remote data broadcast location, said ODU including a transmitter, a horn, and a Low Noise Block (LNB) unit and wherein the LNB unit incorporates or acts as an Ortho mode transducer (OMT) or splitter/combiner, and filter in addition to a Low Noise Block.

In one embodiment the integrated LNB includes an OMT with no waveguide filter, with the OMT provided as part of the LNB casting or housing. This means that the isolation from the transmitter port to the LNB probe interface is only around 40-45 dB. In the single polar/enhance dual polar cases with the splitter/combiner rather than OMT, this isolation is further reduced to 0-3 dB.

In the dual polarization embodiment the LNB comprises a signal probe, front end low noise amplifier, and filter and further amplification and filtering stages, the number of which depend on desired noise figure, gain and composite filter rejection for a given system.

In the single polarization embodiment an additional printed filter is added between the signal probe and the front end amplifier. This additional filter can also be used in a second embodiment of the dual polarisation solution if additional rejection is required for a given system.

Typically the LNB is manufactured as a single diecast unit and may include a one, two or more printed circuit board assembly therein.

In a further aspect of the invention there is provided a ground terminal outdoor unit (ODU) for the reception and communication of broadcast data from and to a remote data broadcast location, said ODU including a transmitter, a horn, and a Low Noise Block (LNB) unit and wherein the signal received is progressively amplified and filtered as it passes through the apparatus.

By providing the progressive amplification and filtering so the desired isolation/rejection can be achieved without the requirement for the mechanical isolation/filtering techniques of the conventional apparatus to be adopted and so the need for the multi component conventional apparatus is overcome.

Typically said signal passes through at least two stages, each stage comprising an amplification and filtering of the signal.

By providing the series of amplifiers as described these act as buffers between the filters and hence allows the level of rejection and hence isolation of the transmit and receive signals required for the effective operation of the apparatus.

In a further aspect of the invention there is provided a ground terminal outdoor unit (ODU) for the reception and communication of broadcast data from and/or to a remote data broadcast location, said ODU including a transmitter, a horn, and a Low Noise Block (LNB) unit and characterised in that the LNB unit incorporates or acts as a power splitter/combiner in a single polarization mode or enhanced dual polarisation and filter in addition to a Low Noise Block.

In this embodiment the LNB includes or acts as a splitter/combiner and transmitted and received signals are on the same polarisation and a filter is added between the signal probe and the front end amplifier of the ODU. Typically the signal passes through at least two stages, each stage comprising an amplification and filtering of the signal.

Thus the present invention provides apparatus and a system for processing signals which can be provided in an integrated format without the need for separate components to be provided as the apparatus and system of the invention with the progressive amplification and filtering of the transmit signal as described allowing the required isolation of the receive and transmit signals even at the VSAT apparatus operating conditions. It should however be appreciated that the invention as herein described is of use and application in any form of signal receive and transmit apparatus and the description of the invention should be interpreted as relating to said apparatus.

Specific embodiments of the invention are now described with reference to the accompanying drawings, wherein:

The Figure identified as Prior Art illustrates conventional apparatus;

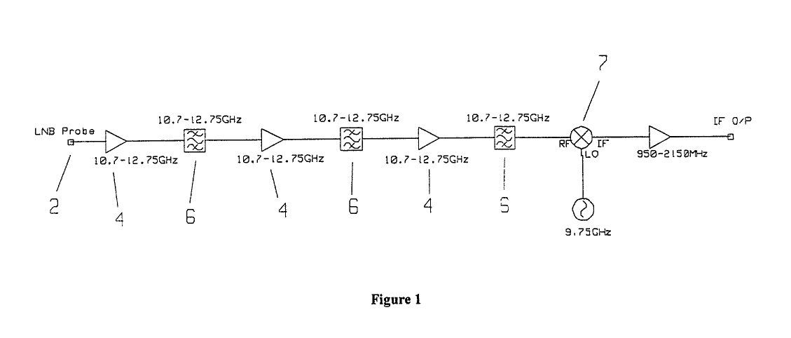

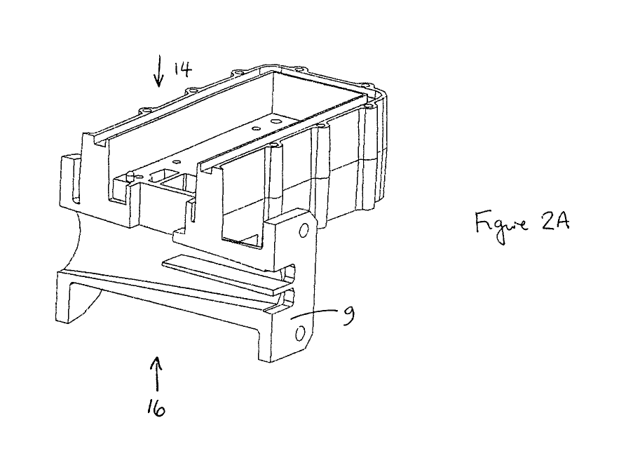

FIG. 1 illustrates in schematic fashion a circuit diagram of the LNB in accordance with one embodiment of the invention;

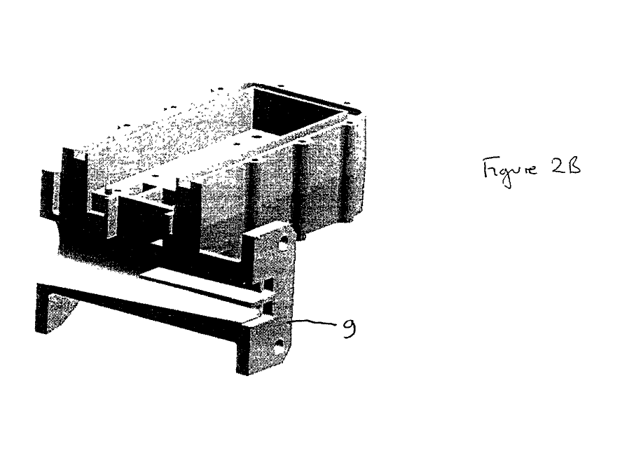

FIGS. 2A-B illustrate sectional views to illustrate the LNB of the apparatus in accordance with the invention;

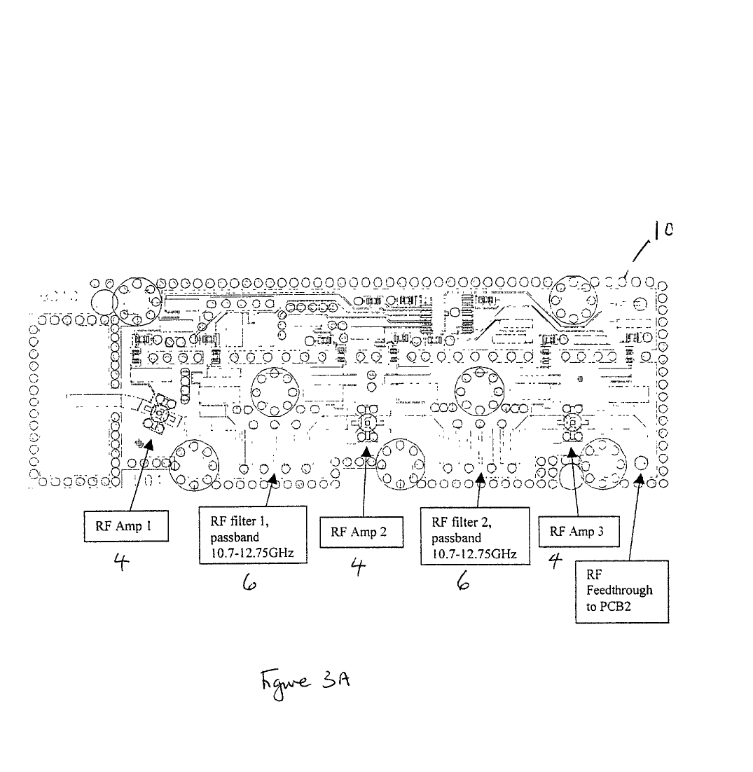

FIGS. 3A-B illustrate two printed circuit boards of the LNB of one embodiment of the invention;

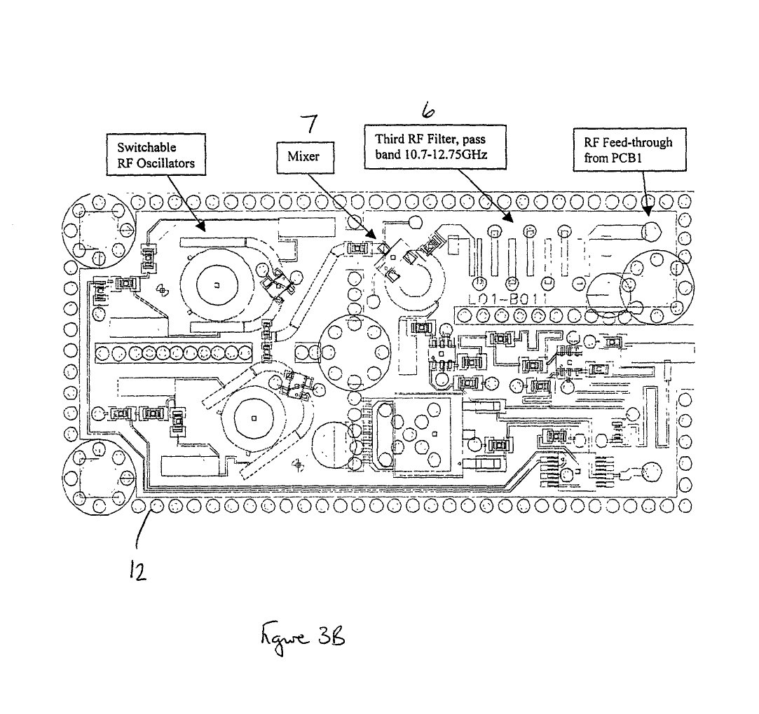

FIGS. 4A-B illustrate elevations from either side of the LNB in part section to illustrate how the printed circuit boards of FIGS. 3A-B fit in the LNB.

Referring firstly to the Prior Art Figure there is shown a conventional VSAT ground terminal outdoor unit ODU which is formed from a series of components, namely a transmitter connection A connected to an ortho mode transducer (OMT) B via one port. Also connected to the OMT is a waveguide filter C which in turn is connected to the Low Noise Block (LNB) D. At the third port of the OMT there is joined a horn E for the reception of the signals. Thus there is provided a five component form of the apparatus which is conventionally used as it is conventionally perceived to be necessary to provide separate, spaced, components in order to provide the required isolation between the transmitted and received signals which pass through the ODU.

However if one now refers to one embodiment of the invention and firstly to FIG. 1 it will be explained how in accordance with the invention, the conventional multicomponent form of the apparatus is no longer necessary and how the ODU can be formed from one or at least a reduced number of components by allowing the LNB to incorporate an OMT function thereby overcoming the need for the separate component or having the LNB incorporate a power splitter and combiner function, depending on the operating characteristics of the ODU.

In FIG. 1 the apparatus comprises an LNB probe 2 connected to a front end LNA (low noise amplifier) 4. The LNA is tuned to a receiver band (10.7-12.75 GHz) but still amplifies the 14-14.5 GHz transmit signal to an extent. This stage has a high enough p1dB to be unaffected by the presence of the transmit signal.

A low loss, high rejection microstrip, or other, filter 6 is positioned after the first stage, and again after 2^{nd} and 3^{rd} RF stages. The number of stages may vary and filters may not be required after all stages as this will depend on required noise figure, gain and rejection.

In this way the transmit signal is progressively amplified as it passes through the stages illustrated and filtered off but is never allowed to reach a level where saturation, intermodulation or additive noise becomes a problem. In this embodiment each microstrip filter provides 30-35 dB rejection and therefore, in theory, overall isolation in the embodiment shown, is 130-150 dB, including the OMT isolation. In reality, with leakage paths, an isolation of 100-125 dB as before is achievable.

The FIGS. 2A-B illustrate cross sectional views of the die cast LNB block or housing, 9, in one embodiment of the invention.

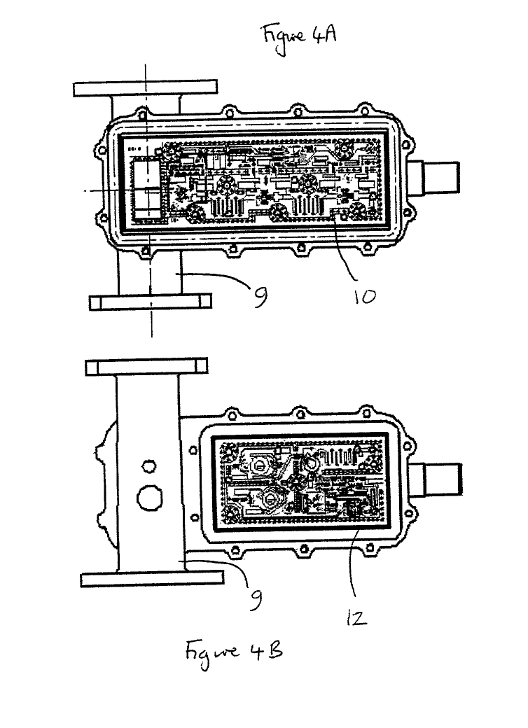

In order to maintain the large isolation value required from the LNB probe to the mixer input 7, the invention in this embodiment uses two isolated printed circuit boards (PCBs) 10 as shown in FIG. 3A and 12 as shown in FIG. 3B although it is feasible that the entire operating functionality could be provided on one PCB. The practical implementations of the invention are illustrated in the PCB's 10,12 with the components referred to using the same reference numerals as shown in FIG. 1

One oscillator is indicated in FIG. 1 but two or more switchable oscillators could be provided as per Universal Single LNB designs. The invention can also be applied to multiple output LNBs with either switchable or fixed outputs.

The position of the respective PCBs 10, 12 with respect to the LNB when fitted is illustrated in FIG. 4A for PCB 10 which is a view in direction 14, as shown in FIG. 2A, and in FIG. 4B for PCB 12 with the view in direction 16.

Another advantage of this implementation is that the loss value of the waveguide filter and two of the waveguide interfaces is removed thus giving this integrated LNB an improved noise figure and hence carrier to noise performance over a conventional system. Insertion loss (and hence noise figure improvement) of the waveguide filter is typically 0.3-0.4 dB which is very significant.

A yet further advantage is the cost saving and reduced number of system components which affords a simpler installation and fewer water leakage or ingress opportunities, as well as an ODU reduction in terms of size and weight.

VSAT systems in the future may well implement dual receive polarisation as per standard DBS TV broadcast. This invention applies equally to any system such as a dual polarization operating mode as described above where the LNB incorporates the OMT function, or in a single polarization mode or enhanced dual polarisation mode where the LNB can include power splitter/combiner function and, in any of the operating modes the LNB also includes the filtering function as described above. In this way the reduced component requirements, size reductions and the like allow associated cost savings to be achieved which are similar in any of the operating modes.

1. A ground terminal outdoor unit (ODU) for the reception and communication of broadcast data from and/or to a remote data broadcast location, said ODU including a transmitter, a horn, and a Low Noise Block (LNB) unit and characterised in that the LNB unit incorporates or acts as an Ortho mode transducer (OMT) in a dual polarization operating mode, and filter in addition to a Low Noise Block.

2. An ODU according to claim 1 characterised in that the LNB includes an OMT with no waveguide filter and the OMT is provided as part of the LNB housing.

3. An ODU according to claim 2 characterised in that the transmitter includes a port and the LNB has a probe interface.

4. An ODU according to claim 3 characterised in that the isolation from the transmitter port to the LNB probe interface is in the region of 40-45 dB.

5. An ODU according to claim 1 characterised in that the LNB comprises a signal probe, front end low noise amplifier, and filter and additional amplification and filtering stages therebetween.

6. An ODU according to claim 1 characterised in that the LNB is manufactured as a diecast unit with a one, two or more printed circuit board assembly therein.

7. A ground terminal outdoor unit (ODU) for the reception and communication of broadcast data from and to a remote data broadcast location, said ODU including a transmitter, a horn, and a Low Noise Block (LNB) unit and characterised in that the signal received is progressively amplified and filtered as it passes through the apparatus.

8. An ODU according to claim 7 characterised in that the signal passes through at least two stages, each stage comprising an amplification and filtering of the signal.

9. A ground terminal outdoor unit (ODU) for the reception and communication of broadcast data from and/or to a remote data broadcast location, said ODU including a transmitter, a horn, and a Low Noise Block (LNB) unit and characterised in that the LNB unit incorporates or acts as a power splitter/combiner in a single polarization mode or enhanced dual polarisation mode, and filter in addition to a Low Noise Block.

10. An ODU according to claim 9 characterised in that the LNB includes or acts as a splitter/combiner and transmitted and received signals are on the same polarisation with or without an additional receive polarisation.

11. An ODU according to claim 9 characterised in that the isolation between the transmitter port and the LNB probe interface is in the region of 0-3 dB.

12. An ODU according to claim 9 characterised in that a filter is provided between the signal probe and the front end amplifier of the ODU.

13. An ODU according to claim 12 characterised in that the LNB comprises a signal probe, front end low noise amplifier, and filter and further amplification and filtering stages.

14. An ODU according to claim 13 characterised in that the signal passes through at least two stages, each stage comprising an amplification and filtering of the signal.
